(19) United States
(12) Patent Application Publication
(10) Pub. No.: US 2015/0095779 A1
(43) Pub. Date: Apr. 2, 2015

(54) ELECTRONIC DEVICE AND METHOD FOR PROVIDING CONTENTS OF THE SAME

(71) Applicant: Samsung Electronics Co., Ltd., Suwon-si (KR)

(72) Inventor: Jinhyung LEE, Seoul (KR)

(21) Appl. No.: 14/501,613

(22) Filed: Sep. 30, 2014

(30) Foreign Application Priority Data
Oct. 2, 2013 (KR) 10-2013-0117823

(51) Int. Cl. H04L 29/06; G06F 3/0482

(52) U.S. Cl. CPC H04L 65/60; G06F 3/0482
USPC 715/716

(57) ABSTRACT

A method of providing contents by using location information and time information of an electronic device is provided. The method includes receiving music service information including at least one music contents play location information, music contents play time information, and a music contents playlist, selecting the playlist according to the at least one music contents play location information and the music contents play time information from the received music service information, and receiving a streaming music contents based on the selected playlist.

### CROSS-REFERENCE TO RELATED APPLICATION(S)

This application claims the benefit under 35 U.S.C. §119(a) of a Korean patent application filed on Oct. 2, 2013 in the Korean Intellectual Property Office and assigned Serial number 10-2013-0117823, the entire disclosure of which is hereby incorporated by reference.

### TECHNICAL FIELD

The present disclosure relates to an electronic device and a method for providing contents by using location and time information. More particularly, the present disclosure relates to an electronic device and a method for providing contents capable of providing music service information according to location and time information, and playing music by using the music service information.

### BACKGROUND

In a music appreciation service of the related art, a user should perform a text search to perform a song search or an album search, and to obtain information used for music appreciation, such as a music recommendation. Hence, when the user has no knowledge of music, the user should be limited in the music appreciation by searching music contents.

Therefore, a need exists for an electronic device and a method for providing contents capable of providing music service information according to location and time information, and playing music by using the music service information.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and a method for providing contents capable of providing music service information according to location and time information, and playing music by using the music service information.

In accordance with an aspect of the present disclosure, a method of providing contents by using location information and time information of an electronic device is provided. The method includes receiving music service information including at least one music contents play location information, music contents play time information, and a music contents playlist, selecting the playlist according to the at least one music contents play location information and the music contents play time information from the received music service information, and receiving a streaming music contents based on the selected playlist.

In accordance with another aspect of the present disclosure, an electronic device is provided. The electronic device includes a communication unit configured to transmit and receive music service information including at least one music contents play location information, music contents play time information, and a music contents playlist and a streaming music contents, a display unit configured to display the music service information, an audio unit configured to play the streaming music contents, and a controller to select a playlist according to at least one music contents play location information and music contents play time information from the received music service information, and receive a streaming music contents based on the selected playlist from the communication unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a signal flow diagram between an electronic device and a server according to an embodiment of the present disclosure;

FIG. 3 is a flowchart illustrating a method for providing contents of an electronic device according to an embodiment of the present disclosure; and

FIG. 4 is a flowchart illustrating a method for providing contents of an electronic device according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

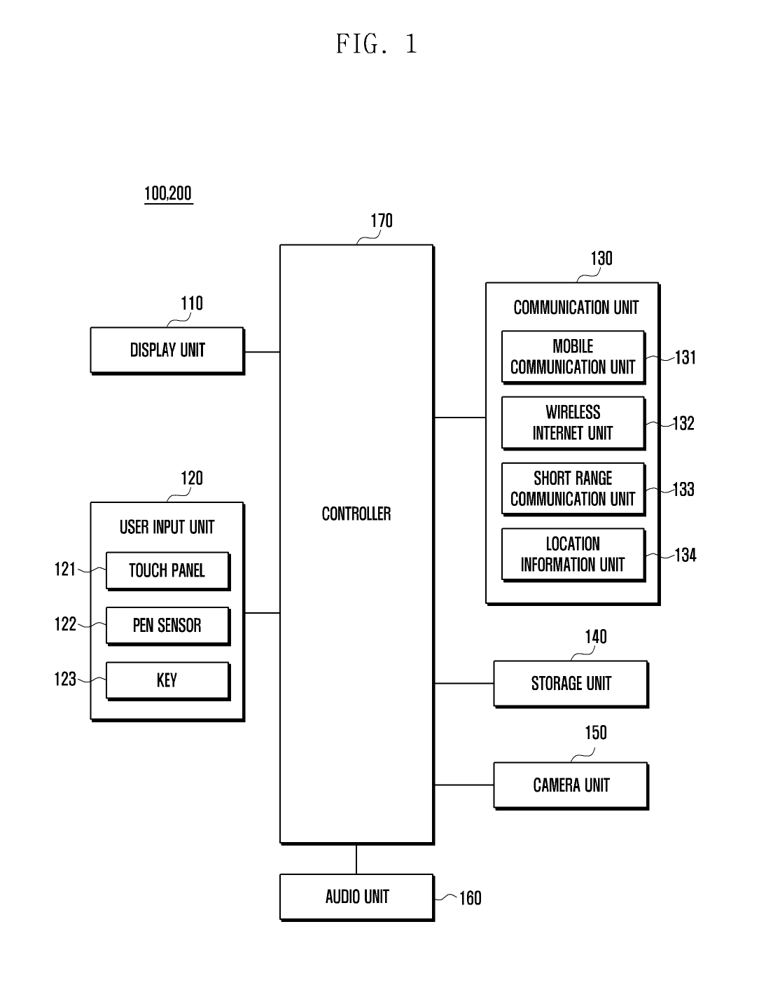

FIG. 1 is a block diagram illustrating a configuration of an electronic device according to an embodiment of the present disclosure.

Referring to FIG. 1, a configuration of an electronic device 100 may be applied to a Smart Phone, but not limited thereto and be applied to various devices. For example, the configuration of the electronic device 100 may also be applied to a tablet Personal Computer (PC), a Portable Multimedia Player (PMP), a Personal Digital Assistant (PDA), a Laptop PC, and a wearable device, such as a Wrist watch, a Head-Mounted Display (HMD), and the like.

Since a first electronic device 101 and a second electronic device 102 have the same configuration as the electronic device 100, hereinafter, a description for the configuration of the electronic device 100 is the same as a description for the configuration of the first electronic device 101 and the second electronic device 102. The electronic device 100 may include a display unit 110, a user input unit 120, a communication unit 130, a storage unit 140, a camera unit 150, an audio unit 160, and a controller 170.

The display unit 110 may perform a function of displaying an image or a data to a user. The display unit 110 may include a display panel. For example, a Liquid-Crystal Display (LCD), an Active-Matrix Organic Light-Emitting Diode (AM-OLED), and the like, may be used for the display panel. At this time, the display unit 110 may further include a controller to control the display panel. The display panel may be implemented, for example, to be flexible, transparent, or wearable.

Meanwhile, the display unit 110 may be provided in the form of a touch screen by combining with a touch panel 121. For example, the touch screen may include a built-in module in which the display panel and the touch panel are coupled with a laminated structure.

According to an embodiment of the present disclosure, the display unit 110 may display music service information according to a location, a time, and a playlist by a user interface under control of the controller 170.

The user input unit 120 may receive various commands from the user. The user input unit 120 may include at least one of, for example, a touch panel 121, a pen sensor 122, or a key 123.

The touch panel 121 may recognize a touch input by a user by at least one of, for example, a capacitive, a resistive, an infrared or an ultrasonic type. The touch panel 121 may further include a controller (not shown). In the meantime, in the case of capacitive type, proximity recognition may be used in addition to a direct touch. The touch panel 121 may further include a Tactile Layer. In this case, the touch panel 121 may provide a tactile response to the user. The pen sensor 122 may be implemented, for example, by using a separate sheet for pen recognition in the same manner as a method of receiving a user's touch input. The key 123 may include, for example, a mechanical key, a touch key, or the like. The mechanical key may include, for example, at least one of a power button provided at one side of the electronic device 100 to turn the display unit of the electronic device 100 on at the time of pushing, a volume button provided at another side of the electronic device 100 to control a volume at the time of pushing, or a home button provided at a center of a lower end of the display unit 110 of the electronic device 100 to move to a home screen at the time of pushing. The touch key may include, for example, at least one of a menu key provided at one portion of a lower end of the display unit 110 of the electronic device 100 to provide a menu related to contents currently being displayed at the time of touch, or a return key provided at one portion of a lower end of the display unit 110 of the electronic device 100 to provide a function of returning to a previous screen of the screen which is currently being displayed at the time of touch.

According to an embodiment of the present disclosure, the display unit 110 may display a location of another electronic device, a music contents play time of the another electronic device, and music service information in accordance with a playlist of music contents of the another electronic device through a user interface under control of the controller 170. For example, the touch panel 121 may detect a touch event to select the location of the another electronic device, the music contents play time of the another electronic device, and the music service information in accordance with a playlist of music contents of the another electronic device.

The communication unit 130 may include at least one of a mobile communication unit 131, a wireless Internet unit 132, a short range communication unit 133, or a location information unit 134. The mobile communication unit 131 may transmit and receive a wireless signal with at least one of a base station, an external terminal, or a server on a mobile communication network. The wireless signal may include a voice call signal, a video call signal, or various types of data according to a transmission and reception of a text/multimedia message.

The wireless Internet unit 132 may perform a function for connection to the wireless Internet. A wireless Internet technology may include a Wireless Local Area Network (WLAN), Wi-Fi, Wireless broadband (Wibro), World Interoperability for Microwave Access (Wimax), High Speed Downlink Packet Access (HSDPA), and the like.

The short range communication unit 133 may perform a function for a short range communication. A short-range communication technology may include Bluetooth, Radio Frequency Identification (RFID), Infrared Data Association (IrDA), Ultra Wideband (UWB), ZigBee, and the like.

The location information unit 134 may perform a function for obtaining or identifying the location of a mobile terminal. The location information unit 134 may obtain location information by using a Global Navigation Satellite System (GNSS). Here, the GNSS is a term used to describe a wireless navigation satellite system that revolves around the earth to transmit reference signals enabling given types of radio navigation receivers to determine their location on the surface of the earth or near the surface of the earth. The GNSS may include a Global Position System (GPS) operated by USA, a Galileo operated by Europe, a Global Orbiting Navigational Satellite System (GLONASS) operated by Russia, a COMPASS operated by China, and a Quasi-Zenith Satellite System (QZSS) operated by Japan.

Additionally, the communication unit 130 may include a network interface (e.g., a LAN card) or a modem to connect the electronic device 100 to a network (e.g., the Internet, a LAN, a Wire Area Network (WAN), a Telecommunication Network, a Cellular Network, a Satellite Network, a Plain Old Telephone Service (POTS), and the like).

According to an embodiment of the present disclosure, under control of the controller 170, the communication unit 130 may collect location information of the electronic device 100 during a streaming of music contents or time information of the electronic device 100 during a streaming of music contents and transmit to the storage unit 140. The location information of the electronic device 100 during a streaming of music contents stored in the storage unit 140 or time information of the electronic device 100 during a streaming of music contents and a playlist of music contents are transmitted to a specific server under control of the controller 170. The communication unit 130 may request a music play to a specific server under control of the controller 170, and may receive music contents provided from the specific server by streaming.

According to various embodiments of the present disclosure, the communication unit 130 may receive the location of at least one other electronic device, the music contents play time of another electronic device, music service information according to a playlist of music contents of another electronic device from a specific server. The communication unit 130 may transmit a request to play music to a specific server according to at least one selected location information and time information under the control of the controller 170. The communication unit 130 may receive a streaming music contents in accordance with the location information and the time information.

The storage unit 140 may include at least one of an internal memory or an external memory.

The internal memory may include at least one of, for example, a volatile memory (e.g., a Dynamic RAM (DRAM), a Static RAM (SRAM), a Synchronous Dynamic RAM (SDRAM), and the like), a nonvolatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, and the like), a Hard Disk Drive (HDD) or a Solid State Drive (SSD). According to an embodiment of the present disclosure, the controller 170 may load and process instruction or data received from at least one of a non-volatile memory or other elements into a volatile memory. Further, the controller 170 may store the data received or generated from other element into a non-volatile memory.

The external memory may include at least one of a Compact Flash (CF), a Secure Digital (SD), a Micro Secure Digital (Micro-SD), a Mini Secure Digital (Mini-SD), an extreme Digital (xD), and a Memory Stick. The storage unit 140 may store an operating system that controls a resource of the electronic device 100 and an application program for an operation of application. The operating system may include a kernel, a middleware, an API, or the like. For example, Android, iOS, Windows, Symbian, Tizen, or Bada may be used as the operating system.

The kernel may include a system resource manager that can manage resources and a device driver. The resource manager may include, for example, a controller management unit, a memory management unit, and a file system management unit, and may perform a function, such as a control, an assignment, a recovery of system resource, and the like. The device driver may access and control various elements of the electronic device 100 in terms of software. To this end, the device driver may be divided into an interface part and an individual driver module part supplied by each hardware company. The device driver may include, for example, at least one of a display driver, a camera driver, a Bluetooth driver, a shared memory driver, a USB driver, a keypad driver, a Wi-Fi driver, an audio driver, an Inter-Process Communication (IPC), and the like.

The middleware may be configured to include a plurality of modules previously implemented to provide a function commonly used in many applications. The middleware may provide a function commonly used through API so that limited system resources within the electronic device may be efficiently used. The middleware may include, for example, at least one of an application manager, a window manager, a multimedia manager, a resource manager, a power manager, a database manager, a package manager, and the like. In addition, the middleware may include at least one of a connectivity manager, a notification manager, a location manager, a graphic manager, a security manager, and the like. In addition, the middleware may include a runtime library or other library modules. The run-time library is a library module used by a compiler to add a new function through a programming language while the application is executed. For example, the runtime library may perform an input and output, a memory management, an arithmetic function, and the like. The middleware may be used by creating a new middleware module through a combination of various functions of the aforementioned internal element modules. Meanwhile, the middleware may provide a module specialized for each type of operating system to provide a differentiated function.

The API is a set of API programming functions, and may be provided as a different configuration according to an operating system. For example, in the case of Android or iOS, for example, one API set may be provided for each platform, and in the case of Tizen, for example, two or more API sets may be provided.

The application may perform at least one function by using an application program. The application may be classified into, for example, a preloaded application or a third party application. The application may include, for example, a Home application which executes a home screen, a Dialer application, a Short Message Server (SMS)/ Multi-media Message Service (MMS) application, an Instant Message (IM) application, a Browser application, a camera application, an Alarm application, a contact list, (e.g., an address book) application, a Voice dial application, an email application, a calendar application, a Media Player, an album application, a watch application, and the like.

According to an embodiment of the present disclosure, the storage unit 140 may store the collected location information or time information of electronic device 100. The camera unit 150 may photograph an image and a video, and may include one or more image sensors (e.g., front lens or rear lens), an Image Signal Processor (ISP) (not shown), and/or a flash LED (not shown).

In the meantime, the camera unit 150 may be configured to include at least part of the processor. For example, the camera unit 150 may include an operation of compensating an image or calculating a characteristic of the image in addition to an operation of obtaining the image. In this case, the camera unit 150 may be a functional module that has a hardware module and a software module. According to an embodiment of the present disclosure, the camera unit 150 may generate face tag information by recognizing a subject's face when obtaining an image.

The audio unit 160 may convert a voice and an electric signal bi-directionally. The audio unit 160 may convert voice information inputted or outputted through, for example, at least one of a speaker, a receiver, an earphone, or a microphone.

According to an embodiment of the present disclosure, the audio unit 160 may play a streaming music contents under control of the controller 170. According to various embodiments of the present disclosure, the audio unit 160 may play a streaming music contents according to location information of another electronic device and time information of another electronic device under control of the controller 170.

The controller 170 may drive an operating system and an application program to control a plurality of hardware and software elements connected to the controller 170 and may perform a processing and calculation of various data including a multi-media data. The controller 170 may be implemented as, for example, a System on Chip (SoC), and further include a Graphical Processing Unit (GPU).

According to an embodiment of the present disclosure, the controller 170 may request a specific server to play music through the communication unit 130. The specific server may provide a music contents by streaming in response to the request of music play of the electronic device 100, and the controller 170 may transmit the streaming music contents transmitted through the communication unit 130 to the audio unit 160 such that the audio unit 160 may play the music contents. The electronic device 100 may collect information related to a list of music contents being streamed under the control of the controller 170, a location in which music contents is played, and a time of playing music contents. The controller 170 may transmit the collected information related to the list of music contents being streamed, the location in which music contents is played, and the time of playing music contents to a specific server.

According to various embodiments of the present disclosure, the controller 170 may request a specific server to transmit music service information for playing music through the communication unit 130. The specific server may transmit the music service information including the location, the time, and the music playlist of at least one other electronic device to the electronic device 100 according to the request of the music service information of the electronic device 100. For example, the specific server may transmit the music service information including a playlist according to the location of at least one other electronic device, or a playlist according to the location information and play time information of at least one other electronic device to the electronic device 100 according to the request of the music service information of the electronic device 100. The controller 170 may detect an input to select the location, the time, and the music playlist of at least one other electronic device included in the received music service information from the user input unit 120 and transmit a music play request according to the selected music service information to the specific server through the communication unit 130. The specific server may transmit the streaming music contents to the electronic device 100 due to the music play request according to the selected music service information, and the controller 170 may transmit the streaming music contents according to at least one location information and play time information transmitted through the communication unit 130 to the audio unit 160 so that the audio unit 160 may play the music contents.

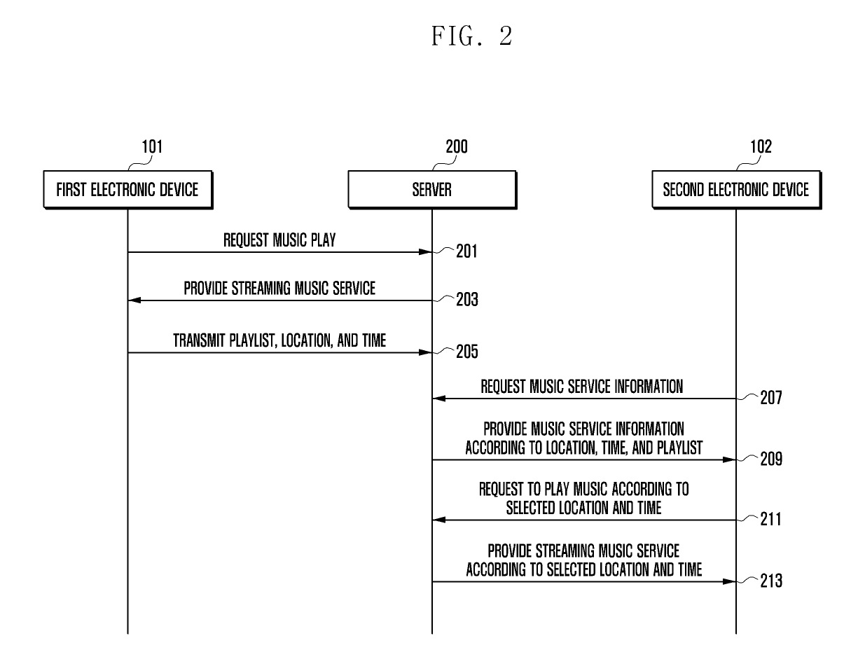

FIG. 2 is a signal flow diagram between an electronic device and a server according to an embodiment of the present disclosure.

Referring to FIG. 2, the first electronic device 101 may request a server 200 to provide a streaming music service at operation 201. For example, the first electronic device 101 may request the server 200 to provide a music play at operation 201. The first electronic device 101 may transmit the music play request inputted from the user input unit 120 to the server 200 through the communication unit 130.

The server 200 may provide the streaming music service in response to a music play request of the first electronic device 101 at operation 203. The first electronic device 101 may receive the streaming music service provided from the server 200 through the communication unit 130, and play the received streaming music service through the audio unit 160.

The first electronic device 101, at operation 205, may transmit information related to a playlist of music contents being streamed, a location in which music contents being streamed is played, and a time of playing music contents being streamed to the server 200. For example, the first electronic device 101, at operation 205, may transmit the information related to the playlist of music contents being streamed, the location in which music contents being streamed is played, and the time of playing music contents being streamed to the server 200 in a message format.

The first electronic device 101 may collect the information related to the list of music contents being streamed, the location in which music contents is played, and the time of playing music contents and store the collected information in the storage unit 140 in order to transmit the information related to the list of music contents being streamed, the location in which music contents is played, and the time of playing music contents to the server 200.

The second electronic device 102 may request the server 200 to provide music service information through the communication unit 130 at operation 207. The music service information may include a music contents playlist according to the location of the first electronic device 101, or a music contents playlist according to a location of the first electronic device 101 and a music contents play time of the first electronic device 101. The music service information may include a music contents playlist according to the location of at least one first electronic device 101 and a music contents playlist according to a music contents play time of the first electronic device 101.

The server 200 provides music service information to the second electronic device 102 at operation 209. For example, at operation 209, the server 200 may transmit the music service information including the music contents playlist according to the location of the first electronic device 101 or the music contents playlist according to the location and the play time of the first electronic device 101 to the second electronic device 102. For example, at operation 209, the server 200 may transmit the music service information including the music contents playlist according to the location of the first electronic device 101 or the music contents playlist according to the location and the play time of the first electronic device 101 to the second electronic device 102 in a message format. For example, at operation 209, the server 200 may transmit the music service information including the music contents playlist according to the location of at least one first electronic device 101 and the music contents playlist according to the music contents play time of the first electronic device 101 to the second electronic device 102 in a message format.

The second electronic device 102 may receive the music service information including the music contents playlist according to the location of the first electronic device 101 or the music contents playlist according to the location and the play time of the first electronic device 101 from the server 200. For example, the second electronic device 102 may receive the music service information including the music contents playlist according to the location of at least one first electronic device 101 and the music contents playlist according to the music contents play time of the first electronic device 101 from the server 200.

The second electronic device 102, at operation 211, may select a playlist according to the location of the first electronic device 101, or a playlist according to the location and the time of the first electronic device 101 from the music service information and request to play music. For example, at operation 211, the second electronic device 102 may select music contents playlist according to the location of at least one first electronic device 101 and the music contents playlist according to the music contents play time of the first electronic device 101 and request to play music.

The server 200, at operation 213, may provide a streaming music service according to the location information and time information of the first electronic device 101 in response to a music play request of the second electronic device 102.

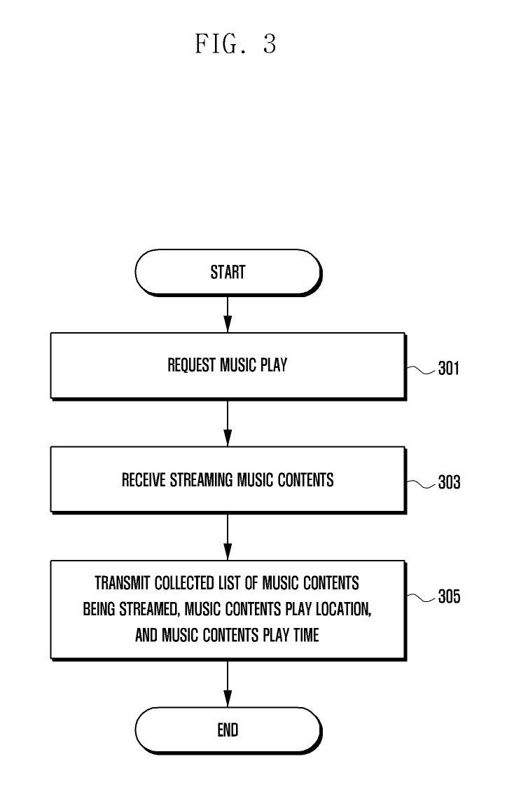

FIG. 3 is a flowchart illustrating a method for providing contents of an electronic device according to an embodiment of the present disclosure.

Referring to FIG. 3, the electronic device 100 may request a music play to a specific server at operation 301.

The specific server may provide music contents by a streaming service in response to the request for music play of the electronic device 100.

The electronic device 100, at operation 303, may receive streaming music contents from the specific server. The electronic device transmits the received streaming music contents to the audio unit 160 such that the audio unit 160 may play the music contents.

The electronic device 100, at operation 305, may collect information related to a list of music contents being streamed, a location in which music contents is played, and a time of playing music contents, and transmit the collected list of music contents being streamed, location in which music contents is played, and time of playing music contents to the specific server.

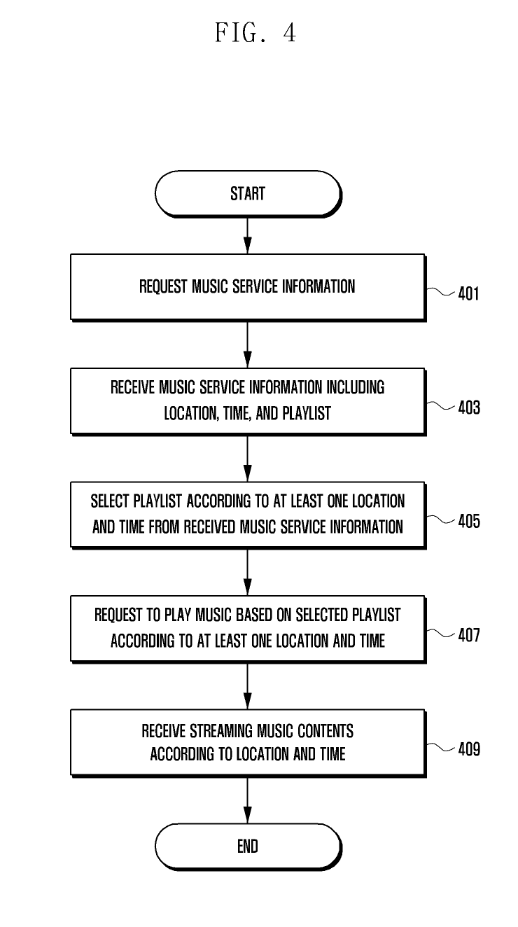

FIG. 4 is a flowchart illustrating a method for providing contents of an electronic device according to an embodiment of the present disclosure.

Referring to FIG. 4, the electronic device 100 may request music service information to a specific server at operation 401.

The music service information may include a music contents playlist according to the music play location of at least one other electronic device, or a music contents playlist according to the music play location and the music play time of at least one other electronic device.

The specific server may transmit the music service information including the music contents playlist according to the music play location of at least one other electronic device, or the music contents playlist according to the music play location and the music play time of at least one other electronic device to the electronic device 100.

The electronic device 100, at operation 403, may receive the music service information including music contents play location information of at least one other electronic device, music contents play time information of another electronic device, and the music contents playlist of another electronic device. For example, the electronic device 100, at operation 403, may receive the music service information including the music contents playlist according to the music play location of at least one other electronic device, or the music contents playlist according to the music play location and the music play time of at least one other electronic device from the specific server.

The electronic device 100, at operation 405, may select a playlist according to the music contents play location information of at least one other electronic device and the music contents play time information of the at least one other electronic device from the received music service information. For example, the electronic device 100, at operation 405, may select the music contents playlist according to the music play location of at least one other electronic device, or the music contents playlist according to the music play location and the music play time of at least one other electronic device from the received music service information.

The electronic device 100, at operation 407, may request the specific server to play music based on the selected playlist according to at least one location information and time information. For example, the electronic device 100, at operation 407, may request the specific server to play music based on the music contents playlist according to the music play location of at least one other electronic device, or the music contents playlist according to the music play location and the music play time of at least one other electronic device.

The electronic device 100, at operation 409, may receive a streaming music contents from the specific server based on the music contents playlist according to the music play location of at least one other electronic device, or the music contents playlist according to the music play location and the music play time of at least one other electronic device.

The contents providing method and the electronic device using the same according to the present disclosure may use location and time information, so that user may use the music service conveniently.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing contents by using location information and time information of an electronic device, the method comprising:
receiving music service information including at least one music contents play location information, music contents play time information, and a music contents playlist;
selecting the playlist according to the at least one music contents play location information and the music contents play time information from the received music service information; and
receiving a streaming music contents based on the selected playlist.

2. The method of claim 1, further comprising requesting a specific server to provide the music service information.

3. The method of claim 2, wherein the receiving of the streaming music contents comprises requesting the specific server to play music based on the selected playlist.

4. The method of claim 1, further comprising collecting information related to a list of music contents being streamed, a location in which music contents being streamed is played, and a time of playing music contents being streamed.

5. The method of claim 4, further comprising transmitting the collected information related to the list of music contents being streamed, the location in which music contents being streamed is played, and the time of playing music contents being streamed.

6. The method of claim 5, further comprising transmitting the collected information related to the list of music contents being streamed, the location in which music contents being streamed is played, and the time of playing music contents being streamed in a message format.

7. The method of claim 6, wherein the receiving of the music service information comprises receiving the music contents play location information of at least one other electronic device, music contents play time information of the at least one other electronic device, and music contents playlist of the at least one other electronic device in the message format.

8. The method of claim 3, further comprising requesting the specific server to play music based on at least one of the music contents playlist according to the music play location of at least one other electronic device, and the music contents playlist according to the music play location and the music play time of at least one other electronic device.

9. An electronic device comprising:
a communication unit configured to transmit and receive music service information including at least one music contents play location information, music contents play time information, and a music contents playlist and a streaming music contents;
a display unit configured to display the music service information;
an audio unit configured to play the streaming music contents; and
a controller configured to select a playlist according to at least one music contents play location information and music contents play time information from the received music service information, and to receive a streaming music contents based on the selected playlist from the communication unit.

10. The electronic device of claim 9, wherein the controller is further configured to control the communication unit to request a specific server to provide the music service information.

11. The electronic device of claim 10, wherein the controller is further configured to control the communication unit to request the specific server to play music based on the selected playlist.

12. The electronic device of claim 9, wherein the controller is further configured to collect information related to a list of the music contents being streamed, a location in which music contents being streamed is played, and a time of playing music contents being streamed.

13. The electronic device of claim 12, wherein the controller is further configured to control the communication unit to transmit the collected information related to the list of music contents being streamed, the location in which music contents being streamed is played, and the time of playing music contents being streamed.

14. The electronic device of claim 13, wherein the controller is further configured to control the communication unit to transmit the collected information related to the list of music contents being streamed, the location in which music contents being streamed is played, and the time of playing music contents being streamed in a message format.

15. The electronic device of claim 14, wherein the controller is further configured to control the communication unit to receive the music contents play location information of at least one other electronic device, music contents play time information of the at least one other electronic device, and music contents playlist of the at least one other electronic device included in the music service information in the message format.

16. The electronic device of claim 11, wherein the electronic device is further configured to request the specific server to play music based on at least one of the music contents playlist according to the music play location of at least one other electronic device, and the music contents playlist according to the music play location and the music play time of at least one other electronic device.
